(19) United States
(12) Patent Application Publication
(10) Pub. No.: US 2013/0240076 A1
(43) Pub. Date: Sep. 19, 2013

(54) PIPE ELEMENT FOR CONSTRUCTING A DOUBLE WALLED PIPELINE

(71) Applicant: Johannes Gerardus van der Graaf, Alphen Aan Den Rijn (NL)

(72) Inventor: Johannes Gerardus van der Graaf, Alphen Aan Den Rijn (NL)

(73) Assignee: HEEREMA MARINE CONTRACTORS NEDERLAND B.V., Leiden (NL)

(21) Appl. No.: 13/816,565

(22) PCT Filed: Aug. 5, 2011
(86) PCT No.: PCT/NL11/50550

§ 371 Date: Mar. 25, 2013

Related U.S. Application Data
(60) Provisional application No. 61/374,733, filed on Aug. 18, 2010.

(30) Foreign Application Priority Data
Aug. 18, 2010 (NL) 2005241

(51) Int. Cl. F16L 9/19; B65H 75/02; F16L 1/16

(52) U.S. Cl. CPC F16L 9/19; F16L 1/16; B65H 75/02
USPC 138/114; 29/428; 242/600; 405/158

(57) ABSTRACT

A pipe element (1) for constructing a double walled pipeline includes an outer pipe element (3) and an inner pipe element (4) located inside the outer pipe element (3), the outer pipe element (3) has a substantially annular form in cross section and includes an inner surface (16). The inner pipe element (4) has a substantially annular form in cross section and includes s an outer surface (15), the diameter of the inner surface is larger than the diameter of the outer surface. The outer pipe element (3) is made from a metallic material, and the inner pipe element (4) is made from a non-metallic material.

### CROSS-REFERENCE TO RELATED APPLICATIONS

This application is the National Stage of International Application No. PCT/NL2011/050550, filed Aug. 5, 2011, which claims the benefit of Netherlands Application No. 2005241, filed Aug. 18, 2010, and the benefit of U.S. Provisional Application No. 61/374,733, filed Aug. 18, 2010, the contents of all of which are incorporated by reference herein.

### FIELD OF THE INVENTION

The invention relates to a pipe element for constructing a double walled pipeline. The pipe element comprises an outer pipe element and an inner pipe element located inside the outer pipe element.

### BACKGROUND OF THE INVENTION

Such a pipe element is known and used for laying a double walled pipeline on the seabed by interconnecting multiple pipe elements. The pipeline may be installed on the seabed and may be used for transporting oil and/or gas. The inner pipe element and outer pipe element of the known pipe element are both made from a metallic material. There is a need for an improved pipe element.

### SUMMARY OF THE INVENTION

The pipe element according the invention comprises an outer pipe element and an inner pipe element located inside the outer pipe element. The outer pipe element has a substantially annular form in cross section and comprises a inner surface. The inner pipe element has a substantially annular form in cross section and comprises an outer surface. The diameter of the inner surface is larger than the diameter of the outer surface. The outer pipe element is made from a metallic material, and the inner pipe element is made from a non-metallic material.

The pipe element according the invention has a lower mass per unit of length when compared with the known pipe element. Due to this, a lower mass is suspending from an installation vessel during the process wherein the pipeline is laid on the seabed. Each vessel for laying such a pipeline has a specific weight carrying capacity. If the weight of a pipeline which has to installed will exceed the specific weight carrying capacity of a vessel, the pipeline cannot be installed with said vessel. A vessel with a higher specific weight carrying capacity will be needed.

The weight of the pipeline is determined by the mass of the pipeline per unit of length and the water depth of the installation location. When the water depth increases, a longer pipeline will be suspending from the vessel. As a result of this, a higher weight has to be carried by the vessel.

As the exploration and production of hydrocarbons is performed in increasing water depths (of more than 2000 meters, or even more than 2500 meters), there is a need to increase the maximal water depth at which a vessel with a specific weight carrying capacity be used for laying the pipeline.

In an embodiment of the pipe element according the invention, the outer pipe element comprises a first longitudinal axis, the inner pipe element comprises a second longitudinal axis and the first longitudinal axis and the second longitudinal axis extend substantially parallel to each other.

At least part of the outer surface of the inner pipe element may be located at a distance from the inner surface of the outer pipe element. The complete outer surface of the inner pipe element may be located at a distance from the inner surface of the outer pipe element.

The pipe element may comprise multiple spacers located between the outer surface of the inner pipe element and the inner surface of the outer pipe element. The spacers may be located at a distance from each other in the direction of the second longitudinal axis. The spacers may be located at a specific distance from each other in the direction of the second longitudinal axis. The spacers may be located at a specific distance of around 2 meters from each other in the direction of the second longitudinal axis.

The spacers may at least partly surround the outer surface of the inner pipe element. The spacers may fully surround the outer surface of the inner pipe element. The spacers may be connected to the outer surface of the inner pipe element. The spacers may have an annular form.

The outer surface of the inner pipe extending between neighboring spacers may be covered by an insulator. An annular space may partly surround the inner pipe element. An annular space may fully surround the inner pipe element.

The invention further relates to a double walled pipeline, wherein;
the pipeline comprises an outer pipeline and an inner pipeline located inside the outer pipeline,
the outer pipeline has a substantially annular form in cross section and comprises an inner surface,
the inner pipeline has a substantially annular form in cross section and comprises an outer surface,
the diameter of the inner surface is larger than the diameter of the outer surface,
the outer pipeline is made from a metallic material, and
the inner pipeline is made from a non-metallic material.

In an embodiment of the pipeline according the invention, the outer pipeline comprises interconnected outer pipe elements which are made from a metallic material. The inner pipeline may comprise interconnected inner pipe elements which are made from a non-metallic material. The pipeline may comprise interconnected pipe elements according to the invention. The inner pipe elements of neighboring pipe elements may be interconnected and the outer pipe elements of neighboring pipe elements may be interconnected.

The outer pipe elements may be interconnected by a metal welding process. The metal welding process may be any type of known metal welding process, such as Gas Metal Arc Welding (GMAW) and Gas Tungsten Arc Welding (GTAW, also known as TIG). The outer pipe elements may be interconnected any other type of connection, such as by mechanical connectors.

The inner pipe elements may be interconnected by a connecting process for non-metallic material. The connecting process for non-metallic material may be any type of known connecting process for non-metallic material, such as fusion (butt, saddle, and electron), welding (heat, friction, laser, extrusion), gluing and the like. The inner pipe elements may be interconnected any other type of connection, such as by mechanical connectors.

The inner pipe element and the inner pipeline may be provided with one or more vents to balance the pressure between the inside of the inner pipe element or the inner pipeline and the annular space in case of an overpressure in the annular space. Certain non metallic materials allow some permeation of gases through the material. Over time this can cause pressure to build up in the annular space. This may lead to collapse of the inner pipe element or inner pipeline in the event of sudden pressure loss inside the inner pipe element or inner pipeline. The vents may be provided in mechanical connectors.

The length of the outer pipe elements may be substantially equal to the length of the inner pipe elements. The length of the inner pipe elements may be larger than the length of the outer pipe elements.

The invention further relates to a reel comprising a at least one pipe element according to the invention, wherein the at least one pipe element is reeled upon said reel.

The invention further relates to a reel comprising a pipeline according to the invention, wherein the pipeline is reeled upon said reel.

The invention further relates to a method for producing a double walled pipeline according to the invention. Said method comprises the steps of:
providing multiple outer pipe elements which are made from a metallic material, have a substantially annular form in cross section and comprise an inner surface,
interconnecting the outer pipe elements,
providing an inner pipeline which is made from a non-metallic material, has a substantially annular form in cross section and comprises an outer surface, wherein the diameter of said inner surface is larger than the diameter of said outer surface,
inserting the inner pipeline inside the interconnected outer pipe elements.

The invention further relates to a method for producing a double walled pipeline, said method comprises the steps:
providing at least two pipe elements according to the invention,
interconnecting the inner pipe elements of the at least two pipe elements, and
interconnecting the outer pipe elements of the at least two pipe elements.

The method according the invention may comprise interconnecting the inner pipe elements before the outer pipe elements are interconnected. The method may comprise interconnecting the outer pipe elements before the inner pipe elements are interconnected.

The invention further relates to a method for producing a double walled pipeline according to the invention. Said method comprises the steps of:
providing multiple outer pipe elements which are made from a metallic material, have a substantially annular form in cross section and comprise an inner surface,
interconnecting the outer pipe elements,
providing multiple inner pipe elements which are made from a non-metallic material, have a substantially annular form in cross section and comprise an outer surface, wherein the diameter of said inner surface is larger than the diameter of said outer surface,
interconnecting the inner pipe elements,
inserting the interconnected inner pipe elements inside the interconnected outer pipe elements.

The method according the invention may comprise interconnecting the inner pipe elements by a connecting process for non-metallic material. The method may comprise interconnecting the outer pipe elements in a first processing step and interconnecting the inner pipe elements in a second processing step. The method may comprise performing the first processing step and second processing step at least partly simultaneously. The method may comprise performing the first processing step before the second processing step. The method may comprise performing the second processing step before the first processing step.

The length of the outer pipe elements may be substantially equal to the length of the inner pipe elements. The length of the inner pipe elements may be larger than the length of the outer pipe elements. The method may comprise interconnecting the outer pipe elements by a metal welding process.

The method may comprise providing the inner pipe element by unreeling the inner pipe element from a reel. The method may comprise providing the inner pipe element with spacers attached to the outer surface thereof.

The invention further relates to a method of laying a double walled pipeline from a vessel and on a seabed. Said method comprises the steps of;
providing a reel comprising one of a reeled pipe element according to the invention or a reeled pipeline according to the invention,
unreeling said pipe element or pipeline from the reel, and
lowering said unreeled pipe element or pipeline to the seabed.

The method according the invention may comprise
subsequently providing one of a pipe element according to the invention or a pipeline according to the invention,
interconnecting said subsequently provided pipe element or pipeline to said unreeled pipe element or pipeline, and
lowering the interconnected subsequently provided pipe element or pipeline and unreeled pipe element or pipeline to the seabed.

The method according the invention may comprise
subsequently providing a further reel comprising one of a pipe element according to the invention or a pipeline according to the invention,
interconnecting said subsequently provided pipe element or pipeline to said unreeled pipe element or pipeline, and
lowering the interconnected subsequently provided pipe element or pipeline and unreeled pipe element or pipeline to the seabed.

The invention further relates to the use of the pipe element according to the invention for laying a double walled pipeline on a seabed.

The invention further relates to the use of the pipeline according to the invention for laying a double walled pipeline on a seabed.

According the invention, a pipe element comprises an outer pipe element and an inner pipe element. A pipeline comprises an outer pipeline and an inner pipeline. The outer pipeline may comprise interconnected outer pipe elements. The inner pipeline may comprise interconnected inner pipe elements. The pipeline may comprise interconnected pipe elements.

During the process of laying a pipeline on a seabed;
pipe elements may be interconnected to each other, and/or
a pipe element and a pipeline may be interconnected to each other, and/or
pipelines may be interconnected to each other.

The inner pipe element and the inner pipeline may comprise multiple layers of the same or different non-metallic materials. The inner pipe element and the inner pipeline may be a composite non-metallic material. The non-metallic material may comprise one or more thermoplastic materials, such as Polyethylene (PE), High Density Polyethylene (HDPE), Polypropylene (PP), Polyvinyl chloride (PVC) or Polyvinylidene fluoride (PVDF). The non-metallic material may comprise a reinforcement comprising one or more fibres, such as fibres made from carbon, glass, aramid, iron or steel.

### BRIEF DESCRIPTION OF THE DRAWINGS

FIG. 1 schematically shows a view in perspective of a first embodiment of the pipe element according the invention,

FIG. 2 schematically shows a cross sectional view of a second embodiment of the pipe element according to the invention,

FIG. 3A schematically shows a cross sectional view along line III-III of FIG. 2,

FIG. 3B schematically shows a cross sectional view along line III-III of the pipe element of FIG. 2 in the situation that the inner pipe element is abutting against the outer pipe element,

FIG. 4 schematically shows a side view of an embodiment of the pipeline according to the invention, and

FIG. 5A schematically shows a cross sectional view along line VI-VI of FIG. 4,

FIG. 5B schematically shows a cross sectional view along line VI-VI of FIG. 4 in the situation that the inner pipeline is abutting against the outer pipeline, and

FIG. 6 schematically shows a vessel at sea while laying the pipeline of FIG. 5 on the seabed.

### DETAILED DESCRIPTION OF THE INVENTION

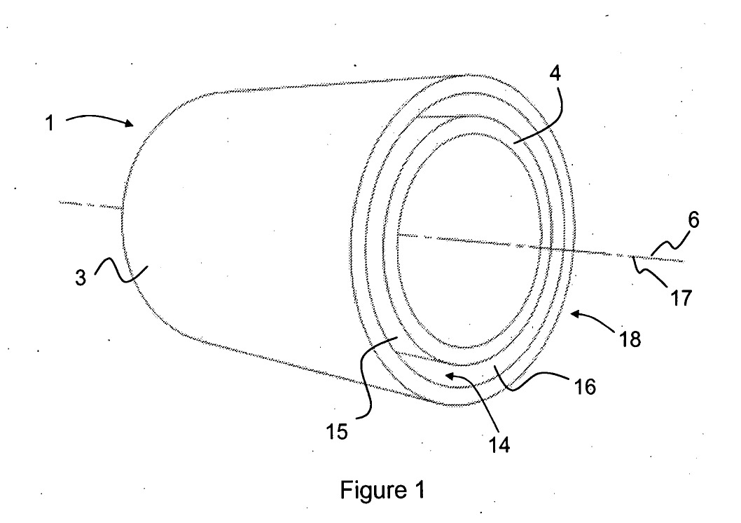

In the FIG. 1-6, the same reference numbers relate to the same or corresponding features.

FIG. 1 shows a first embodiment of the pipe element according the invention. The pipe element 1 is configured for constructing a double walled pipeline 2. The pipe element 1 comprises an outer pipe element 3 and an inner pipe element 4 located inside the outer pipe element 3. The outer pipe element 3 has a substantially annular form in cross section and comprises an inner surface 16. The inner pipe element 4 has a substantially annular form in cross section and comprises an outer surface 15. The diameter of the inner surface is larger than the diameter of the outer surface, thereby forming an annular space 14. The outer pipe element 3 is made from a metallic material. The inner pipe element 4 is made from a non-metallic material.

The outer pipe element 3 comprises a first longitudinal axis 6. The inner pipe element 4 comprises a second longitudinal axis 17. The first longitudinal axis 6 and the second longitudinal axis 17 extend substantially parallel to each other. More specifically, in the pipe element 1 shown in FIG. 1 the first longitudinal axis 6 and the second longitudinal axis 17 substantially coincide.

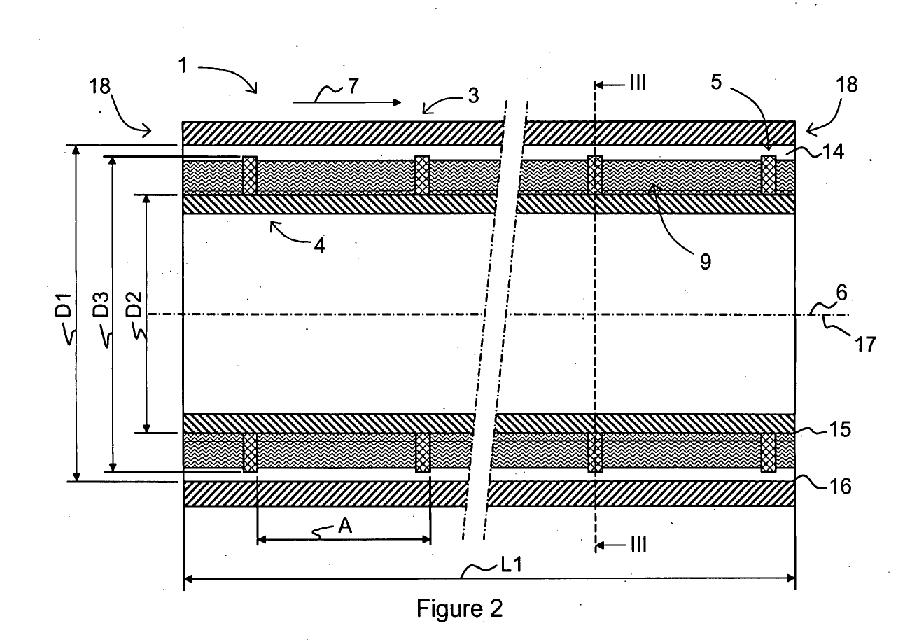

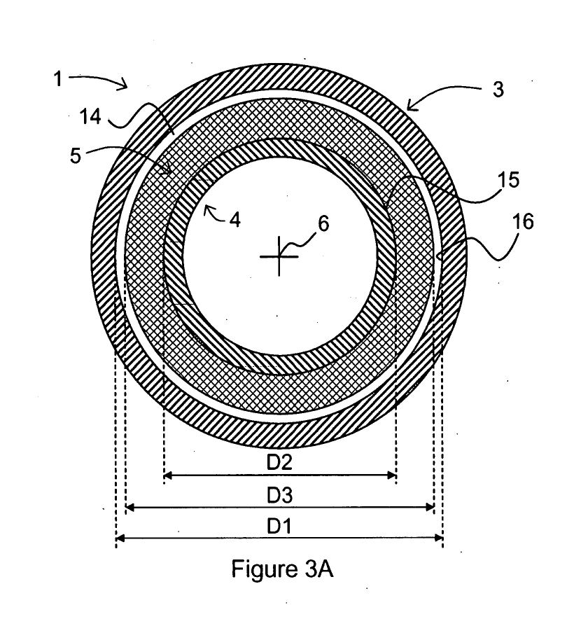

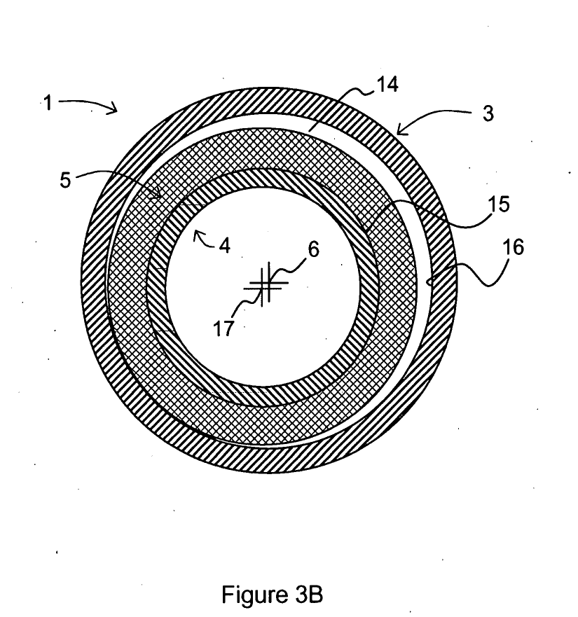

FIG. 2 shows a cross sectional view along the first longitudinal axis of a second embodiment of the pipe element according to the invention. FIG. 3A shows a cross sectional view along line III-III of the pipe element of FIG. 2. The diameter of the inner surface 16 of the outer pipe element 3 is indicated by D1. The diameter of the outer surface 15 of the inner pipe element 4 is indicated by D2. The length of the pipe element 1 is indicated by L1.

The pipe element 1 comprises multiple spacers 5 located between the outer surface 15 of the inner pipe element 4 and the inner surface 16 of the outer pipe element 3. The spacers 5 are located at a distance A from each other in the direction of the second longitudinal axis 17. The spacers 5 fully surround the outer surface 15 of the inner pipe element 4. The spacers 5 are connected to the outer surface 15 of the inner pipe element 4. The spacers 4 have an annular form. The outer diameter of the spacers 5 is indicated by D3.

The spacers 5 are located at a distance A of around 2 meters from each other in the direction of the second longitudinal axis 17. In a further embodiment, the spacers 5 may be located at a different distance A from each other. The distance A may be between 1 and 3 meters from each other in the direction of the second longitudinal axis 17.

The complete outer surface 15 of the inner pipe element 4 is located at a distance from the inner surface 16 of the outer pipe element 3. The outer surface 15 of the inner pipe element 4 extending between neighboring spacers 5 is covered by an insulator 9. More specifically, the outer surface 15 not covered by the spacers 5 is covered by an insulator 9. The annular space 14 fully surrounds the inner pipe element 4 and the spacers 5.

FIG. 3B shows a cross sectional view along line III-III of the pipe element of FIG. 2 in the situation that the inner pipe element 4 is abutting against the outer pipe element 3. More specifically, the spacers 5 are in contact with the inner surface 16 of the outer pipe element 3. The first longitudinal axis 6 and the second longitudinal axis 17 extend substantially parallel to each other. The annular space 14 partly surrounds spacers 14. The annular space 14 may partly surround the inner pipe element 3 along the parts thereof where no spacer 5 is provided. The annular space 14 may fully surround the inner pipe element 3 along the parts thereof where no spacer 5 is provided.

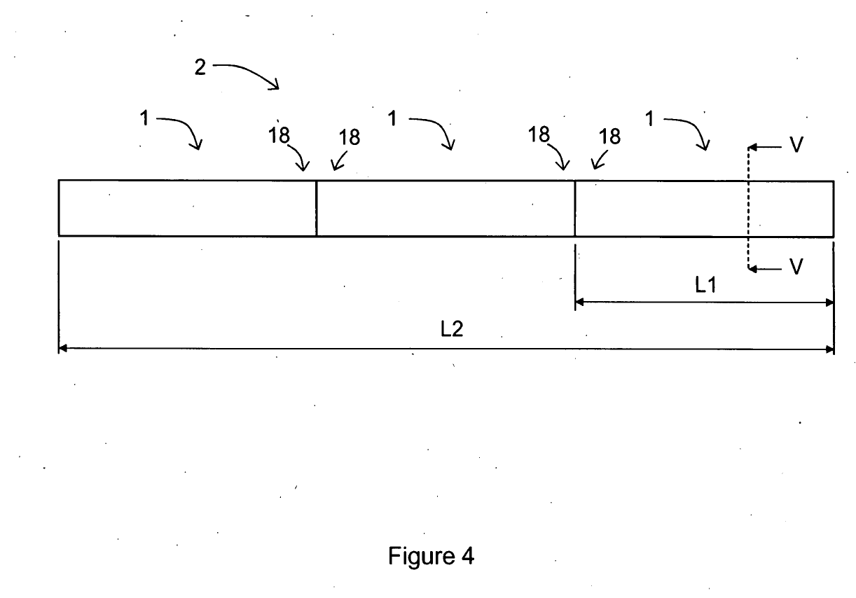

FIG. 4 shows a side view of an embodiment of a pipeline according to the invention. The pipeline 2 comprises three interconnected pipe elements 1 of FIG. 2. The pipe elements 1 are interconnected at their ends 18.

The pipeline 2 may comprise holders for holding the inner pipeline 20 in position relative to the outer pipeline 19. Each holder may be connected to the inner pipeline 20 and the outer pipeline 19. The holders may be provided at the ends 18 of the pipe elements 1. The holders may have a plate-like form and extend radial from the second longitudinal axis 17. The holders may fully seal the annular space 14. This way sealed annular spaces 14 are formed between neighboring holders. Specific types of holders are sometimes referred to as bulkheads.

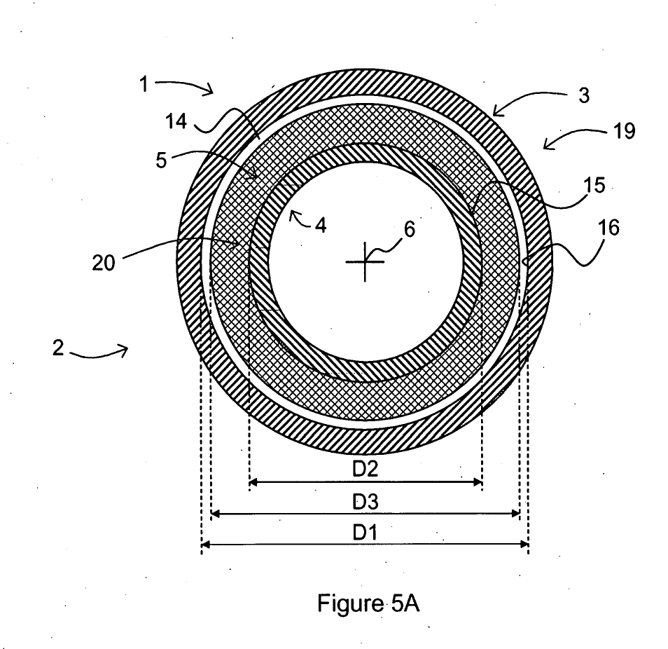

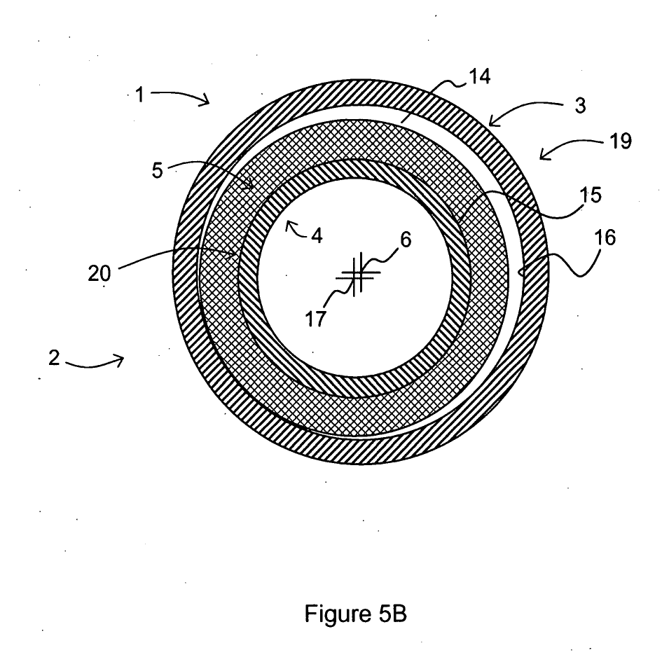

FIG. 5A shows a cross sectional view along line V-V of FIG. 4. The complete outer surface 15 of the inner pipeline 20 is located at a distance from the inner surface 16 of the outer pipeline 19. The first longitudinal axis 6 of the outer pipeline 19 and the second longitudinal axis 17 of the inner pipeline 20 extend substantially parallel to each other, more specifically said first longitudinal axis 6 and said second longitudinal axis 17 substantially coincide. An annular space 14 fully surrounds the inner pipeline 20 and the spacers 5.

FIG. 5B shows a cross sectional view along line V-V of FIG. 5 in the situation that the inner pipeline 20 is abutting against the outer pipeline19. The spacers 5 are in contact with the inner surface 16 of the outer pipeline 15. The first longitudinal axis 6 of the outer pipeline 19 and the second longitudinal axis 17 of the inner pipeline 20 extend substantially parallel to each other. The annular space 14 partly surrounds the spacers 14. The annular space 14 may partly surround the inner pipeline 20 along the parts thereof where no spacer 5 is provided. The annular space 14 may fully surround the inner pipeline 20 along the parts thereof where no spacer 5 is provided.

The pipe element 1 of the FIG. 1-3 is suitable for reeling of the pipe element 1 on a reel. The pipeline 2 of the FIGS. 4 and 5 is suitable for reeling of the pipeline 2 on a reel. This way, the pipeline 2 according the invention may be laid on the seabed by a reeling-process wherein pipe elements 1 of the FIG. 1-3 and/or one or more pipelines 2 of the FIGS. 4 and 5 are unreeled from a reel. The pipeline 2 according the invention may be laid on the seabed by any other pipeline laying process wherein pipe elements 1 of the FIG. 1-3 and/or one or more pipelines 2 of the FIGS. 4 and 5 are interconnected, such as a J-lay process or S-lay process.

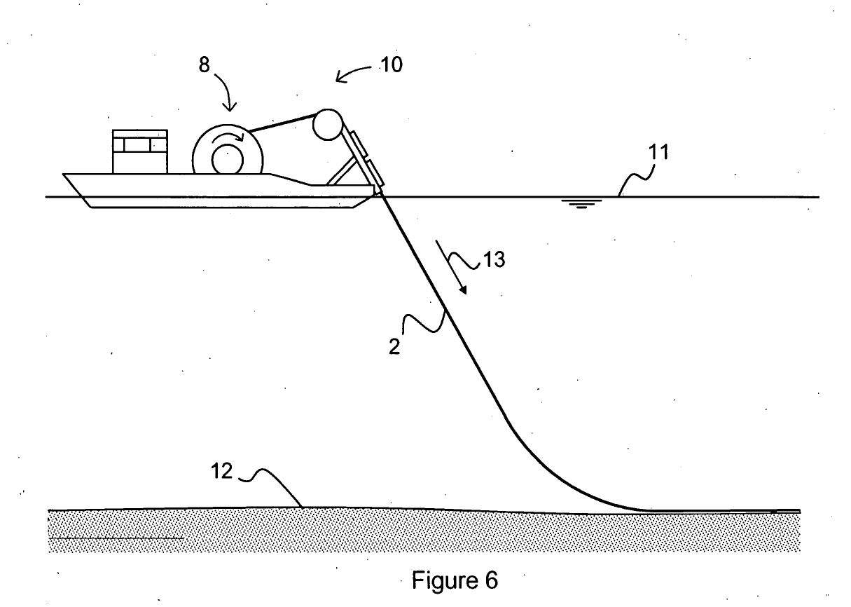

FIG. 6 schematically shows a vessel at sea while laying the pipeline of FIG. 5 on a seabed. The vessel 10 is floating on the water surface 11. The pipeline 2 is located on a reel 8 provided on the vessel 10. The pipeline 2 is unreeled from the reel. The unreeled pipeline 2 is lowered to the seabed 12 in the laying direction 13.

The following clauses are offered as a further description of a pipe element, pipeline, reel, or method according to the invention.

1. Pipe element for constructing a double walled pipeline, wherein;
the pipe element comprises an outer pipe element and an inner pipe element located inside the outer pipe element,
the outer pipe element has a substantially annular form in cross section and comprises a inner surface,
the inner pipe element has a substantially annular form in cross section and comprises an outer surface,
the diameter of the inner surface is larger than the diameter of the outer surface,
the outer pipe element is made from a metallic material, and
the inner pipe element is made from a non-metallic material.

2. Pipe element according to clause 1, wherein the outer pipe element comprises a first longitudinal axis, the inner pipe element comprises a second longitudinal axis and the first longitudinal axis and the second longitudinal axis extend substantially parallel to each other.

3. Pipe element according to clause 1 or 2, wherein a part of the outer surface of the inner pipe element is located at a distance from the inner surface of the outer pipe element.

4. Pipe element according to clause 1 or 2, wherein substantially the complete outer surface of the inner pipe element is located at a distance from the inner surface of the outer pipe element.

5. Pipe element according to any of the preceding clauses, wherein the pipe element comprises multiple spacers located between the outer surface of the inner pipe element and the inner surface of the outer pipe element.

6. Pipe element according to clause 5, wherein the spacers are located at a distance from each other in the direction of the second longitudinal axis.

7. Pipe element according to clause 5 or 6, wherein the spacers partly surround the outer surface of the inner pipe element.

8. Pipe element according to clause 5 or 6, wherein the spacers fully surround the outer surface of the inner pipe element.

9. Pipe element according to any of the clauses 5-8, wherein the spacers are connected to the outer surface of the inner pipe element.

10. Pipe element according to any of the clauses 5-9, wherein the spacers have an annular form.

11. Pipe element according to any of the clauses 5-10, wherein the spacers are located at a distance between 1 and 3 meters from each other in the direction of the second longitudinal axis.

12. Pipe element according to any of the preceding clauses, wherein the outer surface of the inner pipe element is covered by an insulator.

13. Pipe element according to any of the clauses 5-11, wherein the outer surface of the inner pipe element extending between neighboring spacers is covered by an insulator.

14. Pipe element according to any of the clauses 1-13, wherein an annular space partly surrounds the inner pipe element.

15. Pipe element according to any of the clauses 1-13, wherein an annular space fully surrounds the inner pipe element.

16. Pipe element according to clause 14 or 15, wherein the annular space partly surrounds the spacers.

17. Pipe element according to clause 14 or 15, wherein the annular space fully surrounds the spacers.

18. Double walled pipeline, wherein;
the pipeline comprises an outer pipeline and an inner pipeline located inside the outer pipeline,
the outer pipeline has a substantially annular form in cross section and comprises an inner surface,
the inner pipeline has a substantially annular form in cross section and comprises an outer surface,
the diameter of the inner surface is larger than the diameter of the outer surface,
the outer pipeline is made from a metallic material, and
the inner pipeline is made from a non-metallic material.

19. Pipeline according to clause 18, wherein the outer pipeline comprises interconnected outer pipe elements which are made from a metallic material.

20. Pipeline according to clause 18 or 19, wherein the inner pipeline comprises interconnected inner pipe elements which are made from a non-metallic material.

21. Pipeline according to clause 18, wherein the pipeline comprises interconnected pipe elements according to any of the clauses 1-17.

22. Pipeline according to clause 21, wherein the inner pipe elements of neighboring pipe elements are interconnected and the outer pipe elements of neighboring pipe elements are interconnected.

23. Pipeline according to any of the clauses 19, 21 or 22, wherein the outer pipe elements are interconnected by a metal welding process.

24. Pipeline according to any of the clauses 20-23, wherein the inner pipe elements are interconnected by a connecting process for non-metallic material.

25. Pipeline according to any of the clauses 19 or 21-24, wherein the length of the outer pipe elements is substantially equal to the length of the inner pipe elements.

26. Pipeline according to any of the clauses 20-25, wherein the length of the inner pipe elements is larger than the length of the outer pipe elements.

27. Pipeline according to any of the clauses 18-26, wherein the inner pipeline is provided with at least one vent to balance the pressure between the inside of the inner pipeline and an annular space between the outer pipeline and the inner pipeline.

28. Pipeline according to any of the clauses 18-27, wherein the non-metallic material of the inner pipeline comprises a reinforcement comprising one or more fibres, such as fibres made from carbon, glass, aramid, iron or steel.

29. Pipe element according to any of the clauses 14-17, wherein the inner pipe element is provided with at least one vent to balance the pressure between the inside of the inner pipe element and the annular space.

30. Pipe element according to any of the clauses 14-17 and 29, wherein the non-metallic material of the inner pipe element comprises a reinforcement comprising one or more fibres, such as fibres made from carbon, glass, aramid, iron or steel.

31. Reel comprising at least one pipe element according to any of the clauses 1-17, 29 and 30, wherein the at least one pipe element is reeled upon said reel.

32. Reel comprising a pipeline according to any of the clauses 18-28, wherein the pipeline is reeled upon said reel.

33. Method for producing a double walled pipeline according to clause 18, said method comprising the steps of:
providing multiple outer pipe elements which are made from a metallic material, have a substantially annular form in cross section and comprise an inner surface,
interconnecting the outer pipe elements,
providing an inner pipeline which is made from a non-metallic material, has a substantially annular form in cross section and comprises an outer surface, wherein the diameter of said inner surface is larger than the diameter of said outer surface,
inserting the inner pipeline inside the interconnected outer pipe elements.

34. Method for producing a double walled pipeline, said method comprising the steps:
providing at least two pipe elements according to any of the clauses 1-17, 29 and 30,
interconnecting the inner pipe elements of the at least two pipe elements, and
interconnecting the outer pipe elements of the at least two pipe elements.

35. Method for producing a double walled pipeline according to clause 18, said method comprising the steps of:
providing multiple outer pipe elements which are made from a metallic material, have a substantially annular form in cross section and comprise an inner surface,
interconnecting the outer pipe elements,
providing multiple inner pipe elements which are made from a non-metallic material, have a substantially annular form in cross section and comprise an outer surface, wherein the diameter of said inner surface is larger than the diameter of said outer surface,
interconnecting the inner pipe elements,
inserting the interconnected inner pipe elements inside the interconnected outer pipe elements.

36. Method according to any of the clauses 34-35, wherein the method comprises interconnecting the inner pipe elements by a connecting process for non-metallic material.

37. Method according to any of the clauses 34-36, wherein the method comprises interconnecting the outer pipe elements in a first processing step and interconnecting the inner pipe elements in a second processing step.

38. Method according to clause 37, wherein the method comprises performing the first processing step and second processing step at least partly simultaneously.

39. Method according to clause 37, wherein the method comprises performing the first processing step before the second processing step.

40. Method according to clause 37, wherein the method comprises performing the second processing step before the first processing step.

41. Method according to any of the clauses 34-40, wherein the length of the outer pipe elements is substantially equal to the length of the inner pipe elements.

42. Method according to any of the clauses 34-40, wherein the length of the inner pipe elements is larger than the length of the outer pipe elements.

43. Method according to any of the clauses 33-42, wherein the method comprises interconnecting the outer pipe elements by a metal welding process.

44. Method according to any of the clauses 34-43, wherein the method comprises providing the inner pipe element by unreeling the inner pipe element from a reel.

45. Method according to any of the clauses 34-44, wherein the method comprises providing the inner pipe element with spacers attached to the outer surface thereof.

46. Method according to clause 33, wherein the method comprises providing the inner pipeline by unreeling the inner pipeline from a reel.

47. Method according to clause 33 or 46, wherein the method comprises providing the inner pipeline with spacers attached to the outer surface thereof.

48. Method of laying a double walled pipeline from a vessel and on a seabed, comprising the steps of';
providing a reel comprising one of;
a reeled pipe element according to any of the clauses 1-17, 29 and 30 or
a reeled pipeline according to any of the clauses 18-28,
unreeling said pipe element or pipeline from the reel, and
lowering said unreeled pipe element or pipeline to the seabed.

49. Method according to clauses 48, wherein the method comprises
subsequently providing one of;
a pipe element according to any of the clauses 1-17, 29 and 30 or
a pipeline according to any of the clauses 18-28,
interconnecting said subsequently provided pipe element or pipeline to said unreeled pipe element or pipeline, and
lowering the interconnected subsequently provided pipe element or pipeline and unreeled pipe element or pipeline to the seabed.

50. Method according to clauses 48, wherein the method comprises
subsequently providing a further reel comprising one of;
a pipe element according to any of the clauses 1-17, 29 and 30 or
a pipeline according to any of the clauses 18-28,
interconnecting said subsequently provided pipe element or pipeline to said unreeled pipe element or pipeline, and
lowering the interconnected subsequently provided pipe element or pipeline and unreeled pipe element or pipeline to the seabed.

51. Use of the pipe element according to any of the clauses 1-17, 29 and 30, for laying a double walled pipeline on a seabed.

52. Use of the pipeline according to any of the clauses 18-28, for laying a double walled pipeline on a seabed.

1-52. (canceled)

53. A pipe element for constructing a double walled pipeline, wherein;
the pipe element comprises an outer pipe element and an inner pipe element located inside the outer pipe element;
the outer pipe element has a substantially annular form in cross section and comprises a inner surface;
the inner pipe element has a substantially annular form in cross section and comprises an outer surface;
the diameter of the inner surface is larger than the diameter of the outer surface;
the outer pipe element is made from a metallic material; and
the inner pipe element is made from a non-metallic material.

54. The pipe element according to claim 53, wherein a part of the outer surface of the inner pipe element is located at a distance from the inner surface of the outer pipe element.

55. The pipe element according to claim 53, wherein the pipe element comprises multiple spacers located between the outer surface of the inner pipe element and the inner surface of the outer pipe element wherein the spacers partly surround the outer surface of the inner pipe element.

56. The pipe element according to claim 55, wherein an annular space partly or fully surrounds the inner pipe element and the annular space fully surrounds the spacers.

57. A double walled pipeline, wherein;
the double walled pipeline comprises an outer pipeline and an inner pipeline located inside the outer pipeline;
the outer pipeline has a substantially annular form in cross section and comprises an inner surface;
the inner pipeline has a substantially annular form in cross section and comprises an outer surface;
the diameter of the inner surface is larger than the diameter of the outer surface;
the outer pipeline is made from a metallic material and comprises interconnected outer pipe elements which are made from a metallic material; and
the inner pipeline is made from a non-metallic material and comprises interconnected inner pipe elements which are made from a non-metallic material.

58. The pipeline according to claim 57, wherein the inner pipeline is provided with at least one vent to balance the pressure between the inside of the inner pipeline and an annular space between the outer pipeline and the inner pipeline.

59. The pipeline according to claim 57, wherein the non-metallic material of the inner pipeline comprises a reinforcement comprising one or more fibres, such as fibres made from carbon, glass, aramid, iron or steel.

60. The pipe element according to claim 56, wherein the non-metallic material of the inner pipe element comprises a reinforcement comprising one or more fibres, such as fibres made from carbon, glass, aramid, iron or steel.

61. A reel comprising at least one pipe element according to claim 53, wherein the at least one pipe element is reeled upon said reel.

62. A reel comprising a pipeline according to claim 57, wherein the pipeline is reeled upon said reel.

63. A method for producing a double walled pipeline according to claim 57, said method comprising the steps of:
providing multiple outer pipe elements which are made from a metallic material; have a substantially annular form in cross section and comprise an inner surface;
interconnecting the outer pipe elements;
providing an inner pipeline which is made from a non-metallic material; has a substantially annular form in cross section and comprises an outer surface; wherein the diameter of said inner surface is larger than the diameter of said outer surface; and
inserting the inner pipeline inside the interconnected outer pipe elements.

64. A method for producing a double walled pipeline according to claim 57, said method comprising the steps of:
providing multiple outer pipe elements which are made from a metallic material; have a substantially annular form in cross section and comprise an inner surface;
interconnecting the outer pipe elements;
providing multiple inner pipe elements which are made from a non-metallic material;
have a substantially annular form in cross section and comprise an outer surface; wherein the diameter of said inner surface is larger than the diameter of said outer surface;
interconnecting the inner pipe elements;
inserting the interconnected inner pipe elements inside the interconnected outer pipe elements.

65. The method according to claim 64, wherein the method comprises interconnecting the outer pipe elements in a first processing step and interconnecting the inner pipe elements in a second processing step.

66. The method according to claim 65, wherein the method comprises performing the first processing step and second processing step at least partly simultaneously.

67. The method according to claim 65, wherein the method comprises performing the first processing step before the second processing step.

68. The method according to claim 64, wherein the length of the inner pipe elements is larger than the length of the outer pipe elements.

69. The method according to claim 64, wherein the method comprises providing the inner pipe element by unreeling the inner pipe element from a reel.

70. The method according to claim 63, wherein the method comprises providing the inner pipeline by unreeling the inner pipeline from a reel.

71. A method of laying a double walled pipeline from a vessel and on a seabed, comprising the steps of:
providing a reel comprising one of:
a reeled pipe element, the reeled pipeline comprising:
an outer pipe element and an inner pipe element located inside the outer pipe element;
the outer pipe element has a substantially annular form in cross section and comprises a inner surface;
the inner pipe element has a substantially annular form in cross section and comprises an outer surface;
the diameter of the inner surface is larger than the diameter of the outer surface;
the outer pipe element is made from a metallic material; and
the inner pipe element is made from a non-metallic material; or;
a reeled pipeline comprising:
an outer pipeline and an inner pipeline located inside the outer pipeline;
the outer pipeline has a substantially annular form in cross section and comprises an inner surface;
the inner pipeline has a substantially annular form in cross section and comprises an outer surface;
the diameter of the inner surface is larger than the diameter of the outer surface;
the outer pipeline is made from a metallic material and comprises interconnected outer pipe elements which are made from a metallic material; and
the inner pipeline is made from a non-metallic material and comprises interconnected inner pipe elements which are made from a non-metallic material;
unreeling said pipe element or pipeline from the reel; and
lowering said unreeled pipe element or pipeline to the seabed.

72. The method according to claims 71, wherein the method comprises:
subsequently providing one of:
a pipe element comprising:
an outer pipe element and an inner pipe element located inside the outer pipe element;
the outer pipe element has a substantially annular form in cross section and comprises a inner surface;
the inner pipe element has a substantially annular form in cross section and comprises an outer surface;
the diameter of the inner surface is larger than the diameter of the outer surface;
the outer pipe element is made from a metallic material; and
the inner pipe element is made from a non-metallic material; or;
a pipeline comprising:
an outer pipeline and an inner pipeline located inside the outer pipeline;
the outer pipeline has a substantially annular form in cross section and comprises an inner surface;
the inner pipeline has a substantially annular form in cross section and comprises an outer surface;
the diameter of the inner surface is larger than the diameter of the outer surface;
the outer pipeline is made from a metallic material and comprises interconnected outer pipe elements which are made from a metallic material; and
the inner pipeline is made from a non-metallic material and comprises interconnected inner pipe elements which are made from a non-metallic material;
interconnecting said subsequently provided pipe element or pipeline to said unreeled pipe element or pipeline, and
lowering the interconnected subsequently provided pipe element or pipeline and unreeled pipe element or pipeline to the seabed.
